(19) United States
(12) Patent Application Publication
(10) Pub. No.: US 2026/0066771 A1
(43) Pub. Date: Mar. 5, 2026

(54) Drive Circuit

(71) Applicant: Joulwatt Technology Co., Ltd., Hangzhou City (CN)

(72) Inventor: Hao DONG, Hangzhou (CN)

(21) Appl. No.: 19/312,764

(22) Filed: Aug. 28, 2025

(30) Foreign Application Priority Data
Aug. 30, 2024 (CN) 202411218416.0

(51) Int. Cl. H02M 1/08; H02M 3/156

(52) U.S. Cl. CPC H02M 1/08; H02M 3/156

(57) ABSTRACT

A drive circuit is provided. The drive circuit comprises: a driver having a first power supply terminal for receiving a first voltage signal, a second power supply terminal coupled to an current output terminal of a power transistor to receive a second voltage signal, and an output terminal coupled to a control terminal of the power transistor; a drive supply circuit, configured to switch a power supply path that supplies the first voltage signal to the first power supply terminal following a variation of the second voltage signal at a switching node. The drive current is automatically switched in response to rise of the second voltage signal, so that a rate of change of the drive current is reduced during a turn-on process of the power transistor, thereby helping to reduce switching noise, improve EMI performance, and suppress ringing at the switching node.

### CROSS-REFERENCE TO RELATED APPLICATIONS

This present disclosure claims priority to a Chinese patent application No. 202411218416.0, filed on Aug. 30, 2025, and entitled “Drive Circuit, Controller and Switch Power Supply”, the entire contents of which are incorporated herein by reference, comprising the specification, claims, drawings and abstract.

### FIELD OF TECHNOLOGY

The present disclosure relates to a field of switching drive technology, and in particular to a drive circuit.

### BACKGROUND

A switching power supply mainly comprises a power stage circuit having a power transistor and a controller having a drive circuit. The power stage circuit is used to perform conversion from an input voltage to an output voltage, and usually comprises a power transistor and an inductor. The drive circuit in the controller can drive the power transistor in the power stage circuit to turn on or off quickly, so as to adjust the conversion efficiency of the power stage circuit. At present, the topology of the power stage circuit mainly comprises a buck structure, a boost structure, a boost-buck structure, and so on.

However, in a switching power supply, when the power transistor turns on too quickly, the voltage rise speed and fall speed of the current output terminal SW of the power transistor in the power stage circuit will also be too fast. Due to the existence of parasitic inductance, this will cause an excessively large overshoot or undershoot at the current output terminal SW, thereby resulting in a risk of decreased lifetime or even direct damage to the power stage circuit.

### SUMMARY

In order to solve the above technical problems, the present disclosure provides a drive circuit, aiming at reducing the rate of change of drive current, reducing switching noise, improving EMI performance, and reducing ringing.

According to a first aspect of the present disclosure, a drive circuit applied to a switching power supply is provided, the drive circuit comprising:

a driver having an input terminal for receiving a control signal, a first power supply terminal for receiving a first voltage signal, a second power supply terminal coupled to a current output terminal of a power transistor in the switching power supply at a switching node to receive a second voltage signal, and an output terminal coupled to a control terminal of the power transistor; during a turn-on process of the power transistor, the driver outputting a corresponding drive current to the control terminal of the power transistor;

a drive supply circuit, coupled to the first power supply terminal of the driver and the switching node, configured to switch a power supply path that supplies the first voltage signal to the first power supply terminal following a variation of the second voltage signal at the switching node, the driver automatically switching the drive current following a switching of the power supply path.

Optionally, the drive supply circuit comprises an isolation device,
the power supply path comprises a first power supply path and a second power supply path, the first power supply path is located between the first power supply terminal and a preset voltage source, the second power supply path is located between the first power supply terminal and the second power supply terminal,
a first terminal of the isolation device is connected to the preset voltage source, and a second terminal of the isolation device is connected to the first power supply terminal.

Optionally, the isolation device comprises a first diode, and the drive supply circuit automatically switches the power supply path in accordance with on and off states of the first diode within different voltage ranges of the second voltage signal.

Optionally, the switching of the power supply path corresponds to a switching of equivalent resistance, and the power supply paths before and after the switching have different equivalent resistances.

Optionally, when the second voltage signal is within a first voltage range, a power supply path of the drive supply circuit supplying the first voltage signal to the first power supply terminal is the first power supply path, and the driver outputs a first drive current to the control terminal of the power transistor by use of an equivalent resistance of the first power supply path;
when the second voltage signal is within a second voltage range, the drive supply circuit supplies the first voltage signal to the first power supply terminal through both the first power supply path and the second power supply path, and the driver outputs a second drive current to the control terminal of the power transistor;
when the second voltage signal is within a third voltage range, a power supply path of the drive supply circuit supplying the first voltage signal to the first power supply terminal is the second power supply path, and the driver outputs a third drive current to the control terminal of the power transistor by use of an equivalent resistance of the second power supply path,
wherein the equivalent resistance of the second power supply path is greater than the equivalent resistance of the first power supply path, the first drive current is greater than the second drive current, and the second drive current is greater than the third drive current.

Optionally, within the second voltage range, when the second voltage signal rises gradually, the power supply path supplying the first voltage signal gradually switches from the first power supply path toward the second power supply path.

Optionally, the drive supply circuit comprises a first diode coupled in the first power supply path, and the drive supply circuit automatically switches the power supply path in accordance with on and off states of the first diode within different voltage ranges of the second voltage signal.

Optionally, the drive supply circuit is configured such that a cathode potential of the first diode rises with an increase of the second voltage signal, and the first diode gradually switches from a forward conducting state to a reverse cutoff state after the second voltage signal rises beyond the first voltage range;
during a period of the first diode being forward conducting, the drive supply circuit supplies the first voltage signal to the first power supply terminal by use of the first power supply path;
during a transition period of the first diode from forward conducting to reverse cutoff, the drive supply circuit supplies the first voltage signal to the first power supply terminal by use of both the first power supply path and the second power supply path;
after the first diode is reverse cutoff, the drive supply circuit supplies the first voltage signal to the first power supply terminal by use of the second power supply path.

Optionally, the drive supply circuit further comprises:
an energy storage element, coupled in the second power supply path, with a second terminal coupled to the switching node to serve the second voltage signal at the switching node as a reference potential;
a charging unit, coupled to a first terminal of the energy storage element and configured to charge the energy storage element,
wherein the drive supply circuit configures a cathode potential of the first diode to rise with an increase of the second voltage signal based on a potential change of the first terminal of the energy storage element relative to the second voltage signal.

Optionally, the drive supply circuit further comprises:
a resistance unit, coupled between the first terminal of the energy storage element and the first power supply terminal, the equivalent resistance of the second power supply path comprising an effective resistance of the resistance unit.

Optionally, during a period of the second voltage signal being less than a first threshold voltage, the second voltage signal is within the first voltage range;
during a period of the second voltage signal being greater than the first threshold voltage and less than a second threshold voltage, the second voltage signal is within the second voltage range;
during a period of the second voltage signal being greater than the second threshold voltage and a difference between an input voltage of the switching power supply and the second voltage signal being greater than a preset threshold, the second voltage signal is within the third voltage range; or, during the second voltage signal being greater than the second threshold voltage and a delay time after a rising edge of the control signal occurs, the second voltage signal is within the third voltage range.

Optionally, when a rising edge of the control signal occurs, the driver starts to output the first drive current to the control terminal of the power transistor.

Optionally, a magnitude of the second drive current is negatively correlated with a magnitude of the second voltage signal.

Optionally, the preset voltage source comprises:
a first voltage source having a negative pole coupled to a reference ground and a positive pole coupled to an anode of the first diode,
wherein during a period of the first diode being forward conducting, the drive supply circuit provides the first voltage signal by use of the first voltage source and the first diode.

Optionally, the first threshold voltage is equal to zero, and the second threshold voltage is equal to a forward conduction voltage of the first diode.

Optionally, the preset voltage source comprises:
a first voltage source having a negative pole coupled to a reference ground;
a second voltage source having a negative pole coupled to a positive pole of the first voltage source and a positive pole coupled to an anode of the first diode,
wherein during a period of the first diode being forward conducting, the drive supply circuit provides the first voltage signal by use of the first voltage source, the second voltage source and the first diode.

Optionally, the first threshold voltage is equal to an output voltage of the second voltage source, and the second threshold voltage is equal to a sum of the output voltage of the second voltage source and a forward conduction voltage of the first diode.

Optionally, the charging unit comprises:
the first voltage source;
a second diode having an anode coupled to a positive pole of the first voltage source and a cathode coupled to the first terminal of the energy storage element.

Optionally, the charging unit comprises:
a third voltage source having a negative pole coupled to the reference ground;
a second diode having an anode coupled to a positive pole of the third voltage source and a cathode coupled to the first terminal of the energy storage element.

Optionally, the first threshold voltage is equal to a difference between an output voltage of the first voltage source and an output voltage of the third voltage source, and the second threshold voltage is equal to a sum of the difference between the output voltage of the first voltage source and the output voltage of the third voltage source and a forward conduction voltage of the first diode.

Optionally, the resistance unit comprises:
a first resistor having a first terminal coupled to the first terminal of the energy storage element and a second terminal coupled to the first power supply terminal.

Optionally, the resistance unit further comprises:
a first switch, coupled in parallel with the first resistor, the first switch being turned on after a difference between an input voltage of the switching power supply and the second voltage signal is less than a preset threshold, or being turned on after a predetermined delay time following a rising edge of the control signal.

Optionally, the resistance unit comprises a variable resistance device having an effective resistance being adjustable;
the effective resistance of the variable resistance device, after a difference between an input voltage of the switching power supply and the second voltage signal being less than a preset threshold or after a predetermined delay time following a rising edge of the control signal, is less than the effective resistance of the variable resistance device during a period of the second voltage signal being within the third voltage range.

Optionally, the resistance unit further comprises:
a fourth voltage source, coupled in parallel with the first resistor after coupling in series with the first switch.

Optionally, the switching of the power supply path corresponds to a switching of drive supply voltage, the power supply paths before and after the switching provide different drive supply voltages, and the drive supply voltage is a difference between the first voltage signal and the second voltage signal.

Optionally, the power supply path comprises a first power supply path and a second power supply path, the first power supply path being located between the first power supply terminal and a first voltage source, the second power supply path being located between the first power supply terminal and the second power supply terminal,
the second power supply path comprises a second voltage source or an energy storage element, and a voltage of the first voltage source is different from a voltage of the second voltage source or the energy storage element.

Optionally, the driver comprises at least one driver stage, and the first power supply terminal of a last driver stage in the driver is coupled to the first power supply terminal of the driver to receive the first voltage signal.

According to a second aspect of the present disclosure, a controller is provided, comprising the drive circuit according to any one of the above embodiments.

According to a third aspect of the present disclosure, a switching power supply is provided, comprising the controller according to any one of the above embodiments.

Advantageous effects of the present disclosure at least comprise:

The embodiments of the present disclosure configure the drive supply circuit in the drive circuit to automatically switch the supply path that supplies the first voltage signal to the first power supply terminal of the driver in accordance with the variation of the second voltage signal at the switching node, so that during the process in which the driver outputs the drive current according to the first voltage signal and the second voltage signal, the drive current can be automatically switched in accordance with the rise of the second voltage signal at the switching node, thereby realizing multi-stage turn-on of the drive circuit, reducing the rate of change of the drive current during the turn-on process of the power transistor, helping to reduce switching noise, and featuring a simple and reliable circuit structure.

In further specific solutions, the embodiments of the present disclosure configure that in an early stage of the turn-on of the power transistor (for example, during the period of the second voltage signal being less than the second threshold voltage), the power transistor is driven by a larger drive current, which can increase the switching speed of the power transistor and reduce switching losses; while in the late stage of the turn-on of the power transistor (for example, during the period of the second voltage signal being greater than the second threshold voltage and the difference between the input voltage of the switching power supply and the second voltage signal is greater than a preset threshold), the drive current is limited by the resistance unit, so that a smaller drive current is used to limit the rate of change of voltage at the switching node, effectively reducing ringing at the switching node and helping to improve the EMI performance of the system.

It should be noted that the above general description and the following detailed description are merely exemplary and explanatory, and are not intended to limit the present disclosure.

### BRIEF DESCRIPTION OF THE DRAWINGS

FIG. 1 is a circuit diagram of a switching power supply provided in a first embodiment of the present disclosure;

FIG. 2 is a circuit diagram of a switching power supply provided in a second embodiment of the present disclosure;

FIG. 3 is a circuit diagram of a switching power supply provided in a third embodiment of the present disclosure;

FIG. 4 is a circuit diagram of a switching power supply provided in a fourth embodiment of the present disclosure;

FIG. 5 is a circuit diagram of a switching power supply provided in a fifth embodiment of the present disclosure;

FIG. 6 is a circuit diagram of a switching power supply provided in a sixth embodiment of the present disclosure;

FIG. 7 is partial operating waveforms of a switching power supply in some embodiments of the present disclosure.

### DETAILED DESCRIPTION OF THE DISCLOSURE

In order to facilitate understanding of the present disclosure, the present disclosure will be described more fully below with reference to the related drawings. specific embodiments of the present disclosure are given in the drawings. However, the present disclosure can be implemented in many different forms, and is not limited to the embodiments described herein. On the contrary, the purpose of providing these embodiments is to make the disclosure of the present disclosure more thorough and comprehensive.

In the present specification, the reference to “an embodiment” or “some embodiments” or the like means that a particular feature, structure, or characteristic described in connection with the embodiment is comprised in at least one embodiment of the present disclosure. Thus, the phrases “in an embodiment,” “in some embodiments,” “in other embodiments,” “in still other embodiments,” or the like appearing in various places throughout the specification are not necessarily all referring to the same embodiment, but rather mean “one or more but not all embodiments,” unless otherwise expressly specified. The terms “comprise,” “comprise,” “have,” and any variations thereof mean “comprising but not limited to,” unless otherwise expressly specified.

In the description of the present disclosure, the term “exemplary” or “for example” is used to mean serving as an example, instance, or illustration. Any embodiment described herein as “exemplary” or “for example” is not to be construed as necessarily specific or advantageous over other embodiments. The term “and/or” is used to describe an association relationship between associated objects, and indicates that there may be three relationships, for example, A and/or B may indicate: A alone, A and B simultaneously, or B alone. The term “coupled” is used to describe a connection relationship between associated objects, for example, A is coupled to B, which may indicate that A and B are directly connected, or that A and B are indirectly connected through other devices/units/modules. “A plurality of” means two or more. In addition, in order to clearly describe the technical solutions of the embodiments of the present disclosure, the terms “first,” “second,” and the like are used to distinguish between same or similar items or items having substantially the same functions and effects. Those skilled in the art will understand that the terms “first,” “second,” and the like do not limit the quantity or order of execution, and that “first,” “second,” and the like do not necessarily mean different.

In the drawings, the same reference numerals denote the same or similar structures, and repeated descriptions thereof will be omitted, that is, each part in the present specification is described in a parallel and progressive manner, with the emphasis being placed on the differences from other parts, and the same or similar parts between the parts can be referred to each other.

In the related art, the main power transistor control terminal drive schemes of a switching power supply mainly comprise the following:
Scheme 1: The main power transistor adopts a single drive power supply and is driven by a hard switching control method. However, in this scheme, during the turn-on process of the main power transistor, the rate of change of the drive current at the control terminal of the main power transistor is fast, so that oscillation based on the parasitic inductance and parasitic capacitance of the main power transistor may, on one hand, easily cause the voltage spike at the switching node of the switching power supply to be too high, requiring a power transistor with a higher withstand voltage; on the other hand, easily cause the switching noise of the power transistor to be too large, affecting the EMI performance of the system.
Scheme 2: A method of reducing switching speed is adopted, for example, a drive resistor is connected in series at the power supply of the drive circuit, so as to reduce the rate of change of the drive current. However, in this scheme, the degree of reduction in switching speed is fixed, which easily leads to a significant increase in switching losses.
Scheme 3: A multi-stage drive method is adopted, and the switching node voltage at different stages is detected, so as to select and output a corresponding drive current, thereby reducing the rate of change of the drive current. However, this scheme is complex in design, difficult to implement, and high in design cost.
Scheme 4: A method of limiting peak current is adopted to limit the rate of change of the drive current. However, this scheme has an insignificant effect on reducing the voltage ringing at the switching node.

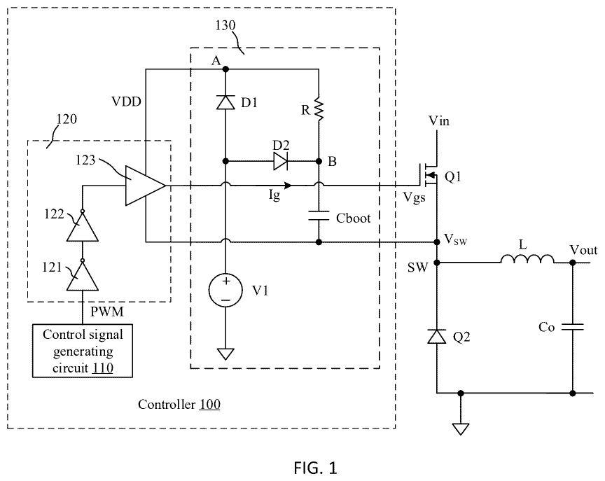

FIGS. 1 to 6 respectively illustrate circuit diagrams of switching power supplies provided in different embodiments of the present disclosure. It should be noted that FIGS. 1 to 6 only show a buck switching power supply topology as an example, and the drive scheme of the present disclosure can also be applied to other non-isolated topologies (such as boost, boost-buck) or isolated topologies (such as forward, flyback, full-bridge or push-pull topologies).

In the examples shown in FIGS. 1 to 6, the switching power supply comprises: a power transistor Q1, a rectifier transistor Q2, an inductor L, an output capacitor Co, and a controller 100.

The power transistor Q1 is coupled between an application terminal of a voltage input terminal Vin and a switching node SW. For example, the power transistor Q1 may be an NMOS transistor, in which case a drain of the power transistor Q1 is coupled to the voltage input terminal of the switching power supply, and the current output terminal of the power transistor Q1 is coupled to the switching node SW.

The rectifier transistor Q2 is, for example, a diode. In this case, a cathode of the rectifier transistor Q2 is coupled to the switching node SW, and an anode of the rectifier transistor Q2 is coupled to a reference ground providing a reference potential.

A first terminal of the inductor L is coupled to the switching node SW, and a second terminal of the inductor L is coupled to a first terminal of the output capacitor Co. A second terminal of the output capacitor Co is coupled to the reference ground. The switching power supply generates an output voltage Vout at the first terminal of the output capacitor Co.

The control circuit 100 comprises a control signal generating circuit 110 and a drive circuit.

The control signal generating circuit 110 generates a control signal (PWM signal) for driving the power transistor Q1. The specific structure and working principle of the control signal generating circuit 110 can be understood with reference to the prior art, and will not be described in detail herein.

The drive circuit is coupled between an output terminal of the control signal generating circuit 110 and a control terminal of the power transistor Q1, and is used to enhance the drive capability of the PWM signal output from the control signal generating circuit 110. The drive circuit can apply a first voltage signal VDD to the control terminal of the power transistor Q1 so as to turn on the power transistor Q1, and can also apply a second voltage signal (i.e., the node voltage of the switching node SW) Vsw to the control terminal of the power transistor Q1 so as to turn off the power transistor Q1.

Further, the drive circuit comprises: a driver 120 and a drive supply circuit 130. An input terminal of the driver 120 receives a control signal (such as a PWM signal), a first power supply terminal of the driver 120 receives the first voltage signal VDD, a second power supply terminal of the driver 120 is coupled to the switching node SW to receive the second voltage signal Vsw, and an output terminal of the driver 120 is coupled to the control terminal of the power transistor Q1. During the turn-on process of the power transistor Q1, the driver 120 outputs a corresponding drive current Ig to the control terminal of the power transistor Q1.

The driver 120 comprises at least one driver stage. In some examples, the driver 120 for example comprises cascaded inverters and a buffer 123, wherein the cascaded inverters correspond to a plurality of pre-driver stages, and the buffer 123 corresponds to the last driver stage. In this embodiment, two cascaded inverters 121 and 122 are taken as an example for description. The drive capability of the inverters increases progressively with the cascade, that is, the drive capability of the inverter 122 is greater than that of the inverter 121, and at the same time, the drive capability of the buffer 123 is the strongest, so that the buffer 123 has sufficient drive capability to switch the potential at the control terminal of the power transistor Q1 between high and low.

Referring to FIG. 1, in this embodiment, the input terminal of the inverter 121 corresponds to the input terminal of the driver 120, the first power supply terminal of the buffer 123 corresponds to the first power supply terminal of the driver 120, the second power supply terminal of the buffer 123 corresponds to the second power supply terminal of the driver 120, and the output terminal of the buffer 123 corresponds to the output terminal of the driver 120.

The drive supply circuit 130 is coupled to the first power supply terminal of the driver 120 and the switching node SW, and is configured to automatically switch the supply path that supplies the first voltage signal VDD to the first power supply terminal of the driver 120 in accordance with the variation of the second voltage signal Vsw at the switching node, so that the driver 120 can automatically switch the drive current Ig in accordance with the automatic switching of the supply path.

Optionally, in some embodiments of the present disclosure, the switching of the supply path is accompanied by or corresponds to a switching of equivalent resistance, and the supply paths before and after the switching have different equivalent resistances.

The structure and working principle of the drive circuit in these embodiments will be further described below with reference to the drawings.

### EMBODIMENT 1

FIG. 1 is a circuit diagram of a switching power supply provided in the first embodiment of the present disclosure.

As shown in FIG. 1, in this embodiment, the supply path comprises a first supply path and a second supply path, the first supply path is located between the first power supply terminal of the driver 120 and a preset voltage source, and the second supply path is located between the first power supply terminal of the driver 120 and the second power supply terminal. The drive supply circuit 130 comprises an isolation device, a first terminal of the isolation device is connected to the preset voltage source, and a second terminal of the isolation device is connected to the first power supply terminal of the driver 120, wherein the drive supply circuit 130 automatically switches the supply path in accordance with the on and off states of the isolation device within different voltage ranges of the second voltage signal Vsw.

In some specific examples, the above isolation device comprises a first diode D1, and the drive supply circuit 130 automatically switches the supply path in accordance with the on and off states of the first diode D1 within different voltage ranges of the second voltage signal Vsw.

When the second voltage signal Vsw is within a first voltage range (for example, during the period of the second voltage signal Vsw being less than a first threshold voltage), the supply path of the drive supply circuit 130 supplying the first voltage signal VDD to the first power supply terminal of the driver 120 is the first supply path, at which time the driver 120 outputs a first drive current (denoted as Ig1) to the control terminal of the power transistor Q1 by use of the equivalent resistance of the first supply path. Further, when a rising edge occurs in the PWM signal, the driver 120 starts to output the first drive current Ig1 to the control terminal of the power transistor Q1, so that the power transistor Q1 can quickly enter a first turn-on stage (such as a Miller plateau turn-on stage).

As the second voltage signal Vsw rises, when the second voltage signal Vsw is within a second voltage range (for example, during the period of the second voltage signal Vsw being greater than the first threshold voltage and less than a second threshold voltage), the drive supply circuit 130 supplies the first voltage signal VDD to the first power supply terminal of the driver 120 by use of both the first supply path and the second supply path, at which time the driver 120 outputs a second drive current (denoted as Ig2) to the control terminal of the power transistor Q1; further, as the second voltage signal Vsw rises gradually, the supply path for supplying the first voltage signal VDD by the drive supply circuit 130 switches step by step from the first supply path to the second supply path;

When the second voltage signal Vsw is within a third voltage range (for example, during the period of the second voltage signal Vsw being greater than the second threshold voltage and a difference between an input voltage Vin of the switching power supply and the second voltage signal Vsw is greater than a preset threshold; or during the period of the second voltage signal Vsw being greater than the second threshold voltage and within a predetermined delay time after a rising edge occurs in the PWM control signal), the supply path of the drive supply circuit 130 supplying the first voltage signal VDD to the first power supply terminal of the driver 120 is completely switched to the second supply path, at which time the driver 120 outputs a third drive current (denoted as Ig3) to the control terminal of the power transistor Q1 by use of the equivalent resistance of the second supply path.

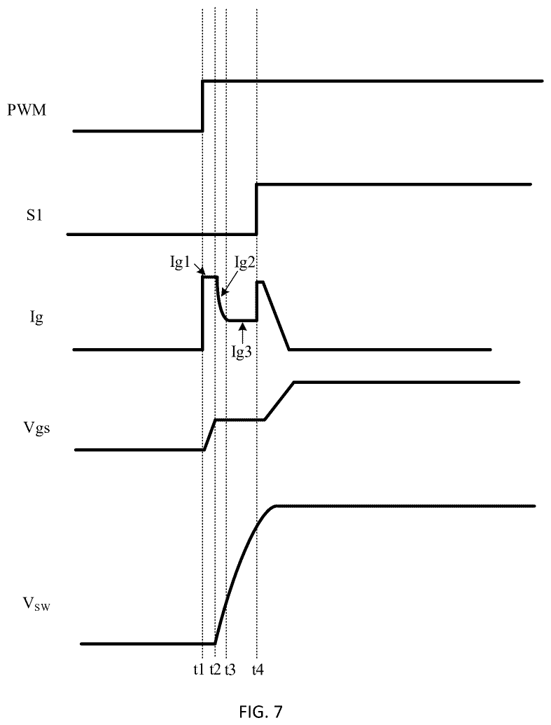

In this embodiment, the equivalent resistance of the second supply path is greater than the equivalent resistance of the first supply path; first drive current Ig1 is greater than second drive current Ig2, and second drive current Ig2 is greater than third drive current Ig3, as shown in FIG. 7. In this way, during the turn-on process of power transistor Q1, a larger drive current is first used to increase switching speed and reduce switching loss; subsequently, a smaller drive current is used to limit the rate of change of the voltage (dv/dt) at switching node SW, thereby solving the ringing at switching node SW and improving system EMI performance.

In some specific examples, the magnitude of second drive current Ig2 is negatively correlated with the magnitude of second voltage signal Vsw, so that a smooth transition is achieved when the drive current is switched.

Illustratively, drive-supply circuit 130 is configured so that the cathode potential (i.e., the potential of node A) of first diode D1 rises with the rise of second voltage signal Vsw, and first diode D1 is gradually switched from forward conduction to reverse cutoff as second voltage signal Vsw rises beyond the first voltage range. During forward conduction of first diode D1, drive-supply circuit 130 uses the first supply path to supply first voltage signal VDD to the first supply terminal of driver 120; during the transition from forward conduction to reverse cutoff, it supplies first voltage signal VDD jointly from the first and the second supply paths; and after first diode D1 is reverse-biased, it uses the second supply path to supply first voltage signal VDD.

Further, drive-supply circuit 130 also comprises: an energy-storage element coupled in the second supply path, and a charging unit coupled to the first terminal of the energy-storage element. The second terminal of the energy-storage element is coupled to switching node SW so that the second voltage signal Vsw at switching node SW serves as its reference potential; the charging unit charges the energy-storage element. Drive-supply circuit 130 configures the cathode potential of first diode D1 to rise with second voltage signal Vsw based on the potential change of the first terminal of the energy-storage element relative to second voltage signal Vsw.

Further, drive-supply circuit 130 also comprises: a resistance unit coupled between the first terminal of the energy-storage element and the first supply terminal; the equivalent resistance of the second supply path comprises the effective resistance of this resistance unit.

In a concrete implementation, as shown in FIG. 1, the energy-storage element is exemplarily chosen to be bootstrap capacitor Cboot, the resistance unit is exemplarily chosen to be first resistor R, and the charging unit exemplarily comprises first voltage source V1 and second diode D2. In the example shown in FIG. 1, the preset voltage source comprises first voltage source V1. The negative pole of first voltage source V1 is coupled to reference ground (or another reference node of fixed potential), its positive pole is coupled to the anode of first diode D1, the cathode of first diode D1 (i.e., node A) is coupled to the first supply terminal of driver 120, the anode of second diode D2 is coupled to the positive pole of first voltage source V1, the cathode of second diode D2 is coupled to the first terminal of bootstrap capacitor Cboot (i.e., node B), the second terminal of bootstrap capacitor Cboot is coupled to switching node SW, the first terminal of first resistor R is coupled to the first terminal of bootstrap capacitor Cboot, and the second terminal of first resistor R is coupled to the first supply terminal of driver 120.

When second voltage signal Vsw is within the first voltage range, first diode D1 is forward-biased and drive-supply circuit 130 uses first voltage source V1 and first diode D1 to provide first voltage signal VDD. When second voltage signal Vsw is within the second voltage range, the forward conduction degree of first diode D1 decreases gradually with the rise of second voltage signal Vsw; drive-supply circuit 130 uses first voltage source V1, first diode D1, bootstrap capacitor Cboot and first resistor R jointly to provide first voltage signal VDD. Specifically, the proportion of first voltage signal VDD provided by first voltage source V1 and first diode D1 decreases gradually, while the proportion provided by bootstrap capacitor Cboot and first resistor R increases correspondingly. When second voltage signal Vsw is within the third voltage range, first diode D1 is reverse-biased and drive-supply circuit 130 uses bootstrap capacitor Cboot and first resistor R to provide first voltage signal VDD.

In this embodiment, the first threshold voltage is exemplarily equal to zero, and the second threshold voltage is equal to the forward conduction voltage of first diode D1 (denoted Vd1); that is, after second voltage signal Vsw exceeds the forward conduction voltage Vd1 of first diode D1, it enters the third voltage range.

In some examples, the last-stage driver unit (e.g., buffer 123) in driver 120 receives its supply voltage at its first supply terminal from the first supply terminal (i.e., node A) of driver 120 and obtains first voltage signal VDD, whereas the first supply terminals of the other driver stages in driver 120 obtain their supply voltages from other circuit nodes (e.g., node B).

Referring to FIG. 7, the working principle of the drive circuit in this embodiment is as follows:

At time t1, the PWM signal received by driver 120 transitions from low to high, i.e., a rising edge appears. During the interval from t1 to t2, first voltage signal VDD is provided by first voltage source V1 and first diode D1, and the ideal voltage of second voltage signal Vsw at switching node SW is zero, so that VDD−Vsw=V1−Vd1. At this time the drive current Ig output by driver 120 is first drive current Ig1, and Ig1=(V1−Vd1−Vgs)/(Rg+R1), where Rg is the equivalent resistance between the first supply terminal and the output terminal of driver 120 and R1 represents the equivalent resistance of the first supply path. Since R1 is approximately zero, first drive current Ig1 can also be expressed as Ig1=(V1−Vd1−Vgs)/Rg. First drive current Ig1 enables power transistor Q1 to enter the first conduction phase rapidly via the Miller effect.

At time t2, power transistor Q1 enters the Miller-plateau conduction phase and second voltage signal Vsw begins to rise from the first threshold voltage. During the interval from t2 to t3, first diode D1 is in transition from forward conduction to reverse cutoff; its forward conduction degree decreases gradually. First voltage signal VDD is provided jointly by first voltage source V1, first diode D1, bootstrap capacitor Cboot and first resistor R. As second voltage signal Vsw rises, the difference between first voltage signal VDD and second voltage signal Vsw decreases gradually, so that during t2-t3 the second drive current Ig2 output by driver 120 decreases gradually as second voltage signal Vsw rises and is negatively correlated with the magnitude of second voltage signal Vsw.

At time t3, second voltage signal Vsw rises above the second threshold voltage (the forward conduction voltage Vd1 of first diode D1), and first diode D1 enters the reverse cutoff state. At this time the potential at the first terminal of bootstrap capacitor Cboot (i.e., node B) is greater than the cathode potential of first diode D1 (i.e., node A), so that first voltage signal VDD is provided by bootstrap capacitor Cboot and first resistor R. The drive current Ig output by driver 120 is now third drive current Ig3, and Ig3=(Vcboot−Vgs)/(Rg+R2), where Vcboot denotes the voltage across bootstrap capacitor Cboot and R2 denotes the equivalent resistance of the second supply path. Since Vcboot is approximately equal to V1−Vd2 and R2 is approximately equal to the resistance of first resistor R, third drive current Ig3 can also be expressed as Ig3=(V1−Vd2−Vgs)/(Rg+R1), where Vd2 denotes the forward conduction voltage of second diode D2. That is, after time t3 the third drive current Ig3 output by driver 120 is independent of the magnitude of second voltage signal Vsw at switching node SW. At this point the drive circuit limits the drive current Ig via resistor R, thereby limiting the rate of change of the voltage at switching node SW and reducing the voltage ringing at switching node SW.

It should be noted that in this embodiment the forward conduction voltages of first diode D1 and second diode D2 are assumed to be equal, i.e., Vd1=Vd2, merely for illustration. In other embodiments of the present disclosure, the forward conduction voltages of first diode D1 and second diode D2 may differ. Moreover, the second threshold voltage in the embodiments of the present disclosure actually refers to the voltage of switching node SW at which first diode D1 is completely cut off.

From the above it can be seen that the drive circuit disclosed in this embodiment adopts dual drive supplies (first voltage signal VDD and second voltage signal Vsw). During the turn-on process of power transistor Q1, it can automatically adjust the supply path of the other drive supply (first voltage signal VDD) according to the voltage change of one drive supply (second voltage signal Vsw). In the early stage of power-transistor conduction (e.g., during t1−t3), a larger drive current is used to drive the power transistor, increasing switching speed and reducing switching loss; in the later stage (e.g., after t3), bootstrap capacitor Cboot and first resistor R supply first voltage signal VDD, so that resistor R can be used to limit the rate of change of the voltage at switching node SW, achieving the goal of reducing voltage ringing at switching node SW. In other words, the drive circuit disclosed in this embodiment can automatically switch the drive current Ig output to the control terminal of power transistor Q1 according to the voltage change at switching node SW. Throughout the entire process, no detection or comparison of switching-node voltage is required, so that automatic multi-segment turn-on of the drive circuit is realized with a simple circuit structure and low design cost.

### EMBODIMENT 2

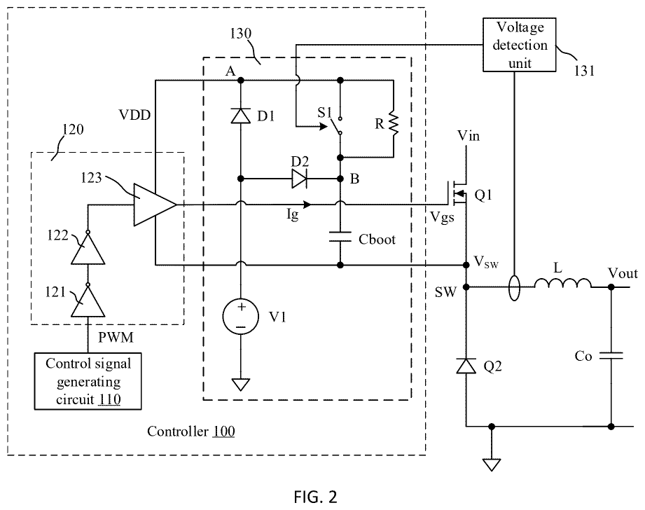

The structure of the switching power supply disclosed in this embodiment is shown in FIG. 2.

Specifically, the switching power supply disclosed in this embodiment adopts the same structure as in the above Embodiment 1; their identical parts will not be repeated.

The differences lie in that: in this embodiment the drive circuit further comprises voltage detection unit 131, and the resistance unit in drive-supply circuit 130 further comprises first switch S1. First switch S1 is coupled in parallel with first resistor R, and voltage detection unit 131 detects second voltage signal Vsw and controls first switch S1 to turn on after detecting that the difference between input voltage Vin of the switching power supply and second voltage signal Vsw is less than a preset threshold.

Of course, in other implementations of the present embodiment, the resistance unit comprising first switch S1 and first resistor R may be replaced by a variable-resistance device having an effective resistance being adjustable; at this time, the variable-resistance device is configured so that its effective resistance after the difference between input voltage Vin and second voltage signal Vsw is less than the preset threshold is smaller than its effective resistance while second voltage signal Vsw is within the third voltage range.

Referring to FIG. 7, compared with the above Embodiment 1, the drive circuit disclosed in this embodiment is further configured to turn on first switch S1 at time t4, i.e., when second voltage signal Vsw is close to input voltage Vin (e.g., when the difference between input voltage Vin and second voltage signal Vsw is less than the preset threshold). At this time drive-supply circuit 130 uses the supply path formed by bootstrap capacitor Cboot and first switch S1 to supply first voltage signal VDD to driver 120, so that power transistor Q1 can quickly enter the normal turn-on phase. It can be understood that after time t4 the drive current Ig output by driver 120 is (V1−Vd2−Vgs)/(Rg+Rs1//R), where Vd2 denotes the forward conduction voltage of second diode D2, Rs1 denotes the on-resistance of first switch S1, the symbol “/” denotes division, and “Rs1//R” denotes the parallel resistance of resistor Rs1 and resistor R.

It can be understood that this embodiment further increases the number of turn-on phases of the drive circuit. While reducing the voltage ringing at switching node SW, it can achieve rapid normal turn-on of power transistor Q1, thereby further reducing switching loss.

### EMBODIMENT 3

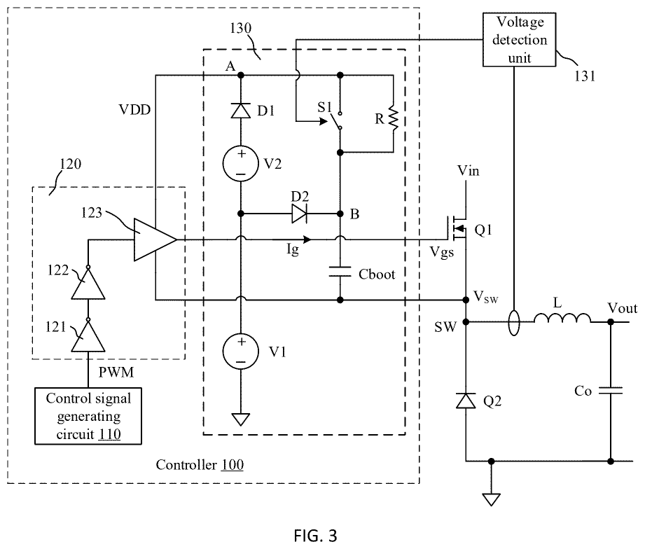

The structure of the switching power supply disclosed in this embodiment is shown in FIG. 3.

Specifically, the switching power supply disclosed in this embodiment adopts the same structure as in the above Embodiment 1 or Embodiment 2; their identical parts will not be repeated.

The differences lie in that: in this embodiment the preset voltage source comprises first voltage source V1 and second voltage source V2.

In the example shown in FIG. 3, drive-supply circuit 130 specifically comprises: first voltage source V1, second voltage source V2, first diode D1, second diode D2, bootstrap capacitor Cboot and first resistor R. The negative pole of first voltage source V1 is coupled to reference ground, its positive pole is coupled to the negative pole of second voltage source V2, the positive pole of second voltage source V2 is coupled to the anode of first diode D1, the cathode of first diode D1 is coupled to the first supply terminal of driver 120, the anode of second diode D2 is coupled to the positive pole of first voltage source V1, the cathode of second diode D2 is coupled to the first terminal of bootstrap capacitor Cboot, the second terminal of bootstrap capacitor Cboot is coupled to switching node SW, the first terminal of first resistor R is coupled to the first terminal of bootstrap capacitor Cboot, and the second terminal of first resistor R is coupled to the first supply terminal of driver 120.

When second voltage signal Vsw is within the first voltage range, first diode D1 is forward-biased and drive-supply circuit 130 uses first voltage source V1, second voltage source V2 and first diode D1 to provide first voltage signal VDD. When second voltage signal Vsw is within the second voltage range, the forward conduction degree of first diode D1 decreases gradually with the rise of second voltage signal Vsw; drive-supply circuit 130 uses first voltage source V1, second voltage source V2, first diode D1, bootstrap capacitor Cboot and first resistor R jointly to provide first voltage signal VDD. Specifically, the proportion of first voltage signal VDD provided by first voltage source V1, second voltage source V2 and first diode D1 decreases gradually, while the proportion provided by bootstrap capacitor Cboot and first resistor R increases correspondingly. When second voltage signal Vsw is within the third voltage range, first diode D1 is reverse-biased and drive-supply circuit 130 uses bootstrap capacitor Cboot and first resistor R to provide first voltage signal VDD.

Further, when drive-supply circuit 130 also comprises first switch S1 coupled in parallel with first resistor R, after second voltage signal Vsw exceeds the third voltage range, i.e., when second voltage signal Vsw is close to input voltage Vin (e.g., when the difference between input voltage Vin and second voltage signal Vsw is less than the preset threshold), first switch S1 turns on. At this time drive-supply circuit 130 uses bootstrap capacitor Cboot and first switch S1 to provide first voltage signal VDD. The turn-on control principle of first switch S1 may be understood with reference to the above Embodiment 2 and will not be repeated here.

In this embodiment, the first threshold voltage is exemplarily equal to the output voltage of second voltage source V2, and the second threshold voltage is equal to the sum of the output voltage of second voltage source V2 and the forward conduction voltage of first diode D1, i.e., V2+Vd1.

The working principle of the drive circuit in this embodiment may be understood with reference to the drive circuits described in the above Embodiment 1 and Embodiment 2 and will not be repeated here. The difference lies in that: in this embodiment time t2 corresponds to the moment when second voltage signal Vsw rises above the first threshold voltage (i.e., V2), and time t3 corresponds to the moment when second voltage signal Vsw rises above the second threshold voltage (i.e., V2+Vd1). That is, by inserting second voltage source V2 between first voltage source V1 and first diode D1, the drive circuit can be controlled so that first resistor R is engaged to adjust drive current Ig only after second voltage signal Vsw rises close to the output voltage of second voltage source V2, thereby enabling flexible control of the timing of adjusting the drive current via first resistor R and offering a wider application range. It is assumed that the output voltage of second voltage source V2 is much greater than the forward conduction voltage Vd1 of first diode D1.

### EMBODIMENT 4

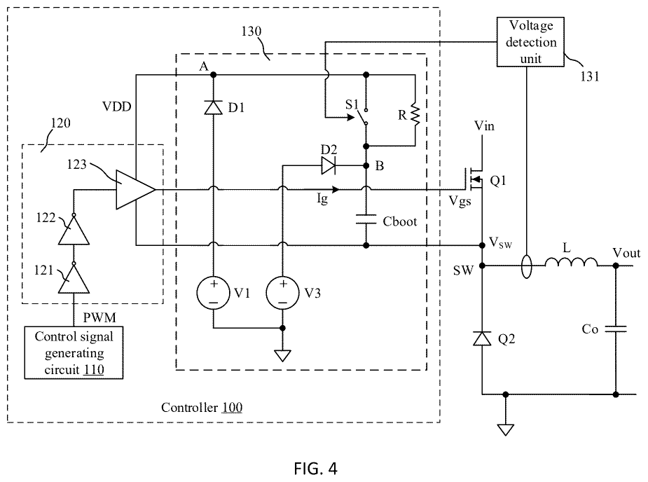

The structure of the switching power supply disclosed in this embodiment is shown in FIG. 4.

Specifically, the switching power supply disclosed in this embodiment adopts the same structure as in the above Embodiment 1, Embodiment 2 or Embodiment 3; their identical parts will not be repeated.

The differences lie in that: in this embodiment the charging unit exemplarily comprises third voltage source V3 and second diode D2.

In the example shown in FIG. 4, drive-supply circuit 130 specifically comprises: first voltage source V1, third voltage source V3, first diode D1, second diode D2, bootstrap capacitor Cboot and first resistor R. The negative pole of first voltage source V1 is coupled to reference ground, its positive pole is coupled to the anode of first diode D1, the cathode of first diode D1 is coupled to the first supply terminal of driver 120, the negative pole of third voltage source V3 is coupled to reference ground, its positive pole is coupled to the anode of second diode D2, the cathode of second diode D2 is coupled to the first terminal of bootstrap capacitor Cboot, the second terminal of bootstrap capacitor Cboot is coupled to switching node SW, the first terminal of first resistor R is coupled to the first terminal of bootstrap capacitor Cboot, and the second terminal of first resistor R is coupled to the first supply terminal of driver 120.

When second voltage signal Vsw is within the first voltage range, first diode D1 is forward-biased and drive-supply circuit 130 uses first voltage source V1 and first diode D1 to provide first voltage signal VDD (if second voltage source V2 is further provided in the first supply path, drive-supply circuit 130 then uses first voltage source V1, second voltage source V2 and first diode D1 to provide first voltage signal VDD). When second voltage signal Vsw is within the second voltage range, the forward conduction degree of first diode D1 decreases gradually with the rise of second voltage signal Vsw; drive-supply circuit 130 uses first voltage source V1, first diode D1, bootstrap capacitor Cboot and first resistor R jointly to provide first voltage signal VDD (if second voltage source V2 is further provided in the first supply path, drive-supply circuit 130 then uses first voltage source V1, second voltage source V2, first diode D1, bootstrap capacitor Cboot and first resistor R jointly to provide first voltage signal VDD). Specifically, the proportion of first voltage signal VDD provided by first voltage source V1 and first diode D1 decreases gradually, while the proportion provided by bootstrap capacitor Cboot and first resistor R increases correspondingly. When second voltage signal Vsw is within the third voltage range, first diode D1 is reverse-biased and drive-supply circuit 130 uses bootstrap capacitor Cboot and first resistor R to provide first voltage signal VDD.

Further, when drive-supply circuit 130 also comprises first switch S1 coupled in parallel with first resistor R, after second voltage signal Vsw exceeds the third voltage range, i.e., when second voltage signal Vsw is close to input voltage Vin (e.g., when the difference between input voltage Vin and second voltage signal Vsw is less than the preset threshold), first switch S1 turns on. At this time drive-supply circuit 130 uses bootstrap capacitor Cboot and first switch S1 to provide first voltage signal VDD. The turn-on control principle of first switch S1 may be understood with reference to the above Embodiment 2 and will not be repeated here.

In this embodiment, the first threshold voltage is equal to the difference between the output voltage of first voltage source V1 and that of third voltage source V3, i.e., V1−V3, and the second threshold voltage is equal to the sum of the difference and the forward conduction voltage of first diode D1, i.e., V1−V3+Vd1.

The working principle of the drive circuit in this embodiment may be understood with reference to the drive circuits described in the above Embodiment 1, Embodiment 2 and Embodiment 3 and will not be repeated here. The difference lies in that: in this embodiment time t2 corresponds to the moment when second voltage signal Vsw rises above the first threshold voltage (i.e., V1−V3), and time t3 corresponds to the moment when second voltage signal Vsw rises above the second threshold voltage (i.e., V1−V3+Vd1). That is, by adding third voltage source V3 and coupling first voltage source V1 and third voltage source V3 to first diode D1 and second diode D2 respectively, the drive circuit can be controlled so that first resistor R is engaged to adjust drive current Ig only after second voltage signal Vsw rises close to V1−V3+Vd1, thereby providing another embodiment for flexibly controlling the timing of adjusting the drive current via first resistor R with a wider application range and greater design flexibility.

### EMBODIMENT 5

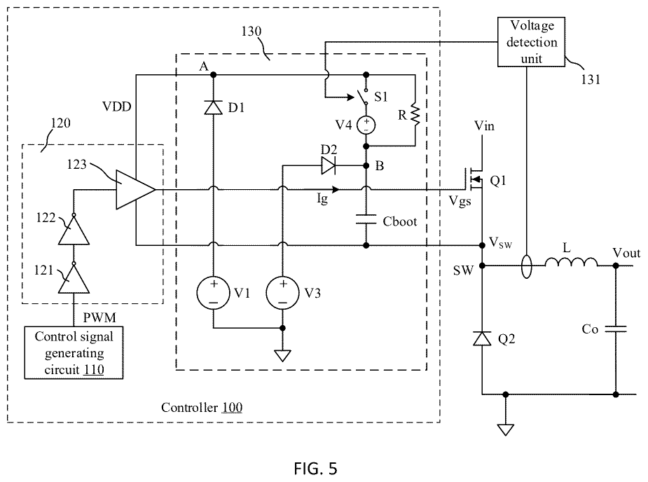

The structure of the switching power supply disclosed in this embodiment is shown in FIG. 5.

Specifically, the switching power supply disclosed in this embodiment adopts the same structure as in the above Embodiment 2, Embodiment 3 or Embodiment 4; their identical parts will not be repeated.

The differences lie in that: in this embodiment the resistance unit further comprises fourth voltage source V4.

In the example shown in FIG. 5, drive-supply circuit 130 specifically comprises: first voltage source V1, third voltage source V3, fourth voltage source V4, first diode D1, second diode D2, bootstrap capacitor Cboot, first switch S1 and first resistor R. The negative pole of first voltage source V1 is coupled to reference ground, its positive pole is coupled to the anode of first diode D1, the cathode of first diode D1 is coupled to the first supply terminal of driver 120, the negative pole of third voltage source V3 is coupled to reference ground, its positive pole is coupled to the anode of second diode D2, the cathode of second diode D2 is coupled to the first terminal of bootstrap capacitor Cboot, the second terminal of bootstrap capacitor Cboot is coupled to switching node SW, the first terminal of first resistor R is coupled to the first terminal of bootstrap capacitor Cboot, the second terminal of first resistor R is coupled to the first supply terminal of driver 120, and fourth voltage source V4 and first switch S1 are coupled in series and then in parallel with first resistor R.

When second voltage signal Vsw is within the first voltage range, first diode D1 is forward-biased and drive-supply circuit 130 uses first voltage source V1 and first diode D1 to provide first voltage signal VDD (if second voltage source V2 is further provided in the first supply path, drive-supply circuit 130 then uses first voltage source V1, second voltage source V2 and first diode D1 to provide first voltage signal VDD). When second voltage signal Vsw is within the second voltage range, the forward conduction degree of first diode D1 decreases gradually with the rise of second voltage signal Vsw; drive-supply circuit 130 uses first voltage source V1, first diode D1, bootstrap capacitor Cboot and first resistor R jointly to provide first voltage signal VDD (if second voltage source V2 is further provided in the first supply path, drive-supply circuit 130 then uses first voltage source V1, second voltage source V2, first diode D1, bootstrap capacitor Cboot and first resistor R jointly to provide first voltage signal VDD). Specifically, the proportion of first voltage signal VDD provided by first voltage source V1 and first diode D1 decreases gradually, while the proportion provided by bootstrap capacitor Cboot and first resistor R increases correspondingly. When second voltage signal Vsw is within the third voltage range, first diode D1 is reverse-biased and drive-supply circuit 130 uses bootstrap capacitor Cboot and first resistor R to provide first voltage signal VDD. After second voltage signal Vsw exceeds the third voltage range, i.e., when second voltage signal Vsw is close to input voltage Vin (e.g., when the difference between input voltage Vin and second voltage signal Vsw is less than the preset threshold), first switch S1 turns on. At this time drive-supply circuit 130 uses bootstrap capacitor Cboot, fourth voltage source V4 and first switch S1 to provide first voltage signal VDD. The turn-on control principle of first switch S1 may be understood with reference to the above Embodiment 2 and will not be repeated here.

In this embodiment, the first threshold voltage is equal to the difference between the output voltage of first voltage source V1 and that of third voltage source V3, i.e., V1−V3, and the second threshold voltage is equal to the sum of the difference and the forward conduction voltage of first diode D1, i.e., V1−V3+Vd1.

The working principle of the drive circuit in this embodiment may be understood with reference to the drive circuits described in the above Embodiment 2, Embodiment 3 and Embodiment 4 and will not be repeated here.

It can be understood that this embodiment can provide a higher first supply voltage VDD to the first supply terminal of driver 120 after second voltage signal Vsw exceeds the third voltage range, thereby achieving a larger drive current.

### EMBODIMENT 6

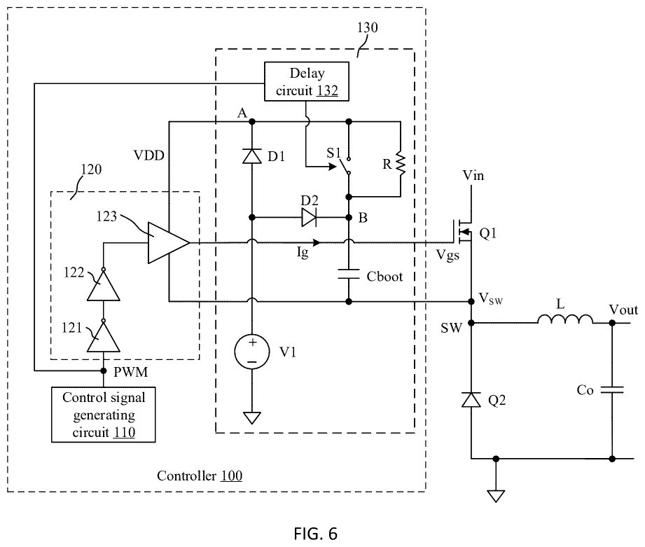

The structure of the switching power supply disclosed in this embodiment is shown in FIG. 6.

Specifically, the switching power supply disclosed in this embodiment adopts the same structure as in any one of the above Embodiments 2-4; their identical parts will not be repeated.

The differences lie in that: in this embodiment delay circuit 132 is used instead of voltage detection unit 131. In the example shown in FIG. 6, the input terminal of delay circuit 132 receives the PWM signal, its output terminal is coupled to the control terminal of first switch S1, and delay circuit 132 is used to control first switch S1 to turn on after a predetermined delay time following the rising edge of the PWM signal.

The drive circuit disclosed in this embodiment adopts a fixed-delay scheme to control the turn-on of first switch S1. Compared with the above Embodiment 2, it requires no sampling of the voltage at switching node SW during the turn-on process of power transistor Q1, so the circuit structure and control scheme are simpler.

Of course, for embodiments in which a variable-resistance device having an effective resistance being adjustable is used as the resistance unit, the variable-resistance device is correspondingly configured so that its effective resistance after the predetermined delay time following the rising edge of the PWM signal is smaller than its effective resistance while second voltage signal Vsw is within the third voltage range.

Further, in other embodiments of the present disclosure, the switching of the supply path through which drive-supply circuit 130 provides first voltage signal VDD to the first supply terminal of driver 120 may correspond to a switching of drive-supply voltages; for example, the supply paths before and after the switching provide different drive-supply voltages, where the drive-supply voltage is the difference between first voltage signal VDD and second voltage signal Vsw.

In these embodiments, the supply path through which drive-supply circuit 130 provides first voltage signal VDD to the first supply terminal of driver 120 comprises a first supply path and a second supply path. The first supply path is located between the first supply terminal and a first voltage source, and the second supply path is located between the first supply terminal and the second supply terminal. In these embodiments, a first isolation device (e.g., first diode) may likewise be arranged in the first supply path between the first supply terminal and the first voltage source, so that drive-supply circuit 130 automatically switches the supply path according to the on/off states of the first isolation device within different voltage ranges of second voltage signal Vsw.

In these embodiments, when second voltage signal Vsw is within the first voltage range, drive-supply circuit 130 uses the first supply path to provide first voltage signal VDD to the first supply terminal of driver 120, so that driver 120 has a first drive-supply voltage; when second voltage signal Vsw is within the second voltage range, drive-supply circuit 130 uses the second supply path to provide first voltage signal to the first supply terminal, so that driver 120 has a second drive-supply voltage and controls power transistor Q1 to operate in the active region; the first drive-supply voltage is greater than the second drive-supply voltage.

In a concrete implementation, the second supply path exemplarily comprises a second voltage source, and the voltage of the first voltage source is different from that of the second voltage source. Further, the second supply path exemplarily also comprises a second isolation device (e.g., second diode) located between the first supply terminal and the second voltage source, so that a more stable and reliable switching of supply paths is achieved. Of course, in other implementations, the second voltage source on the second supply path may be replaced by a first energy-storage element, such as a first capacitor, etc. On this basis, drive-supply circuit 130 further comprises a charging unit for charging the first energy-storage element; this charging unit may, for example, be realized by providing an additional second voltage source.

In further specific examples, the supply path through which drive-supply circuit 130 provides first voltage signal VDD to the first supply terminal of driver 120 further comprises a third supply path located between the first supply terminal and the second supply terminal. In this case, when second voltage signal Vsw is within the third voltage range, drive-supply circuit 130 uses the third supply path to provide first voltage signal VDD to the first supply terminal of driver 120, so that driver 120 has a third drive-supply voltage and controls power transistor Q1 to operate in the saturation region.

In a concrete implementation, optionally, the third supply path exemplarily comprises a third voltage source and a first switch; by controlling the on/off state of the first switch, drive-supply circuit 130 uses the third supply path to provide first voltage signal VDD to the first supply terminal of driver 120 after the absolute value of the difference between second voltage signal Vsw and input voltage Vin of the switching power supply is less than a first preset voltage, or after a first predetermined delay time following the rising edge of the control signal. Of course, in other implementations, the third voltage source on the third supply path may be replaced by a second energy-storage element, such as a second capacitor, etc. On this basis, drive-supply circuit 130 further comprises a charging unit for charging the second energy-storage element; this charging unit may utilize the first voltage source, or may be realized by providing an additional third voltage source.

In summary, in the drive circuits disclosed in the various embodiments of the present disclosure, the driver adopts dual drive supplies to output drive current, and the drive current output by the driver can be automatically switched with the rise of second voltage signal Vsw at switching node SW. During the entire turn-on process of power transistor Q1, it is only necessary to detect whether second voltage signal Vsw at switching node SW is close to system input voltage Vin (in some embodiments it is even unnecessary to detect or compare the voltage at switching node SW), so that multi-segment turn-on control of the drive circuit is realized. This not only avoids excessively high voltage spikes and excessive switching noise at switching node SW, but also reduces the rate of change of drive current during power-transistor turn-on, achieving different rates of drive-current reduction in different stages, effectively reducing switching loss, and yielding a simpler and more reliable circuit structure.

In some specific implementations, the drive-circuit scheme disclosed in the present disclosure can use a larger drive current to drive the power transistor in the early stage of turn-on, facilitating an increase in power-transistor switching speed and a reduction in switching loss; in the later stage of turn-on, the drive current is limited by the resistance unit, so that a smaller drive current is used to limit the rate of change of the voltage at switching node SW, effectively reducing voltage ringing at switching node SW and improving system EMI performance.

Finally, it should be noted that the above embodiments are merely illustrative and are not intended to limit the scope of the present disclosure. For those skilled in the art, various other modifications and variations may be made on the basis of the above description. It is not necessary or possible to exhaust all possible implementations. Any obvious changes or variations derived therefrom still fall within the scope of protection of the present disclosure.

What is claimed is:

1. A drive circuit applied to a switching power supply, the drive circuit comprising:
a driver having an input terminal for receiving a control signal, a first power supply terminal for receiving a first voltage signal, a second power supply terminal coupled to an current output terminal of a power transistor in the switching power supply at a switching node to receive a second voltage signal, and an output terminal coupled to a control terminal of the power transistor; during a turn-on process of the power transistor, the driver outputting a corresponding drive current to the control terminal of the power transistor;
a drive supply circuit, coupled to the first power supply terminal of the driver and the switching node, configured to switch a power supply path of the first voltage signal following a variation of the second voltage signal at the switching node, the driver automatically switching the drive current following a switching of the power supply path.

2. The drive circuit of claim 1, wherein the drive supply circuit comprises an isolation device,
the power supply path comprises a first power supply path and a second power supply path, the first power supply path is located between the first power supply terminal and a preset voltage source, the second power supply path is located between the first power supply terminal and the second power supply terminal,
a first terminal of the isolation device is connected to the preset voltage source, and a second terminal of the isolation device is connected to the first power supply terminal.

3. The drive circuit of claim 2, wherein the isolation device comprises a first diode, and the drive supply circuit automatically switches the power supply path in accordance with on state and off state of the first diode within different voltage ranges of the second voltage signal.

4. The drive circuit of claim 3, wherein the switching of the power supply path corresponds to a switching of equivalent resistance, and the power supply paths before and after the switching have different equivalent resistances.

5. The drive circuit of claim 4, wherein when the second voltage signal is within a first voltage range, the power supply path of the first voltage signal is the first power supply path, and the driver outputs a first drive current to the control terminal of the power transistor by use of an equivalent resistance of the first power supply path;
when the second voltage signal is within a second voltage range, the first voltage signal is supplied through both the first power supply path and the second power supply path, and the driver outputs a second drive current to the control terminal of the power transistor;
when the second voltage signal is within a third voltage range, the power supply path of the first voltage signal is the second power supply path, and the driver outputs a third drive current to the control terminal of the power transistor by use of an equivalent resistance of the second power supply path,
wherein the equivalent resistance of the second power supply path is greater than the equivalent resistance of the first power supply path, the first drive current is greater than the second drive current, and the second drive current is greater than the third drive current.

6. The drive circuit of claim 5, wherein within the second voltage range, when the second voltage signal rises gradually, the power supply path supplying the first voltage signal gradually switches from the first power supply path toward the second power supply path.

7. The drive circuit of claim 3, wherein the drive supply circuit further comprises:
an energy storage element, coupled in the second power supply path, with a second terminal coupled to the switching node to serve the second voltage signal at the switching node as a reference potential;
a charging unit, coupled to a first terminal of the energy storage element and configured to charge the energy storage element,
wherein the drive supply circuit configures a cathode potential of the first diode to rise with an increase of the second voltage signal, based on a potential change of the first terminal of the energy storage element relative to the second voltage signal.

8. The drive circuit of claim 7, wherein the drive supply circuit further comprises:
a resistance unit, coupled between the first terminal of the energy storage element and the first power supply terminal, the equivalent resistance of the second power supply path comprising an effective resistance of the resistance unit.

9. The drive circuit of claim 7, wherein
during a period of the second voltage signal being less than a first threshold voltage, the second voltage signal is within the first voltage range;
during a period of the second voltage signal being greater than the first threshold voltage and less than a second threshold voltage, the second voltage signal is within the second voltage range;
during a period of the second voltage signal being greater than the second threshold voltage and a difference between an input voltage of the switching power supply and the second voltage signal is greater than a preset threshold, the second voltage signal is within the third voltage range; or, during the second voltage signal being greater than the second threshold voltage and a delay time after a rising edge of the control signal occurs, the second voltage signal is within the third voltage range.

10. The drive circuit of claim 5, wherein when a rising edge of the control signal occurs, the driver starts to output the first drive current to the control terminal of the power transistor.

11. The drive circuit of claim 5, wherein a magnitude of the second drive current is negatively correlated with a magnitude of the second voltage signal.

12. The drive circuit of claim 9, wherein in a first case, the preset voltage source comprises a first voltage source having a negative pole coupled to a reference ground and a positive pole coupled to an anode of the first diode, during a period of the first diode being forward conducting, the drive supply circuit providing the first voltage signal by use of the first voltage source and the first diode, wherein in the first case, the first threshold voltage is equal to zero, and the second threshold voltage is equal to a forward conduction voltage of the first diode;
in a second case, the preset voltage source comprises: a first voltage source having a negative pole coupled to a reference ground; and a second voltage source having a negative pole coupled to a positive pole of the first voltage source and a positive pole coupled to an anode of the first diode, during a period of the first diode being forward conducting, the drive supply circuit providing the first voltage signal by use of the first voltage source, the second voltage source and the first diode, wherein in the second case, the first threshold voltage is equal to an output voltage of the second voltage source, and the second threshold voltage is equal to a sum of the output voltage of the second voltage source and a forward conduction voltage of the first diode.

13. The drive circuit of claim 12, wherein the charging unit comprises:
the first voltage source;
a second diode having an anode coupled to a positive pole of the first voltage source and a cathode coupled to the first terminal of the energy storage element.

14. The drive circuit of claim 12, wherein the charging unit comprises:
a third voltage source having a negative pole coupled to the reference ground;
a second diode having an anode coupled to a positive pole of the third voltage source and a cathode coupled to the first terminal of the energy storage element,
wherein the first threshold voltage is equal to a difference between an output voltage of the first voltage source and an output voltage of the third voltage source, and the second threshold voltage is equal to a sum of the difference between the output voltage of the first voltage source and the output voltage of the third voltage source and a forward conduction voltage of the first diode.

15. The drive circuit of claim 8, wherein the resistance unit comprises a first resistor having a first terminal coupled to the first terminal of the energy storage element and a second end coupled to the first power supply terminal; or
the resistance unit comprises: a first resistor having a first terminal coupled to the first terminal of the energy storage element and a second end coupled to the first power supply terminal; and a first switch, coupled in parallel with the first resistor, the first switch being turned on after a difference between an input voltage of the switching power supply and the second voltage signal being less than a preset threshold, or being turned on after a predetermined delay time following a rising edge of the control signal.

16. The drive circuit of claim 8, wherein the resistance unit comprises a variable resistance device having an effective resistance being adjustable;
the effective resistance of the variable resistance device, after a difference between an input voltage of the switching power supply and the second voltage signal being less than a preset threshold or after a predetermined delay time following a rising edge of the control signal, is less than the effective resistance of the variable resistance device during a period of the second voltage signal being within the third voltage range.

17. The drive circuit of claim 8, wherein the resistance unit comprises:
a first resistor having a first terminal coupled to the first terminal of the energy storage element and a second end coupled to the first power supply terminal;
a first switch, coupled in parallel with the first resistor, the first switch being turned on after a difference between an input voltage of the switching power supply and the second voltage signal being less than a preset threshold, or being turned on after a predetermined delay time following a rising edge of the control signal; and
a fourth voltage source, coupled in parallel with the first resistor after coupling in series with the first switch.

18. The drive circuit of claim 1, wherein the switching of the power supply path corresponds to a switching of drive supply voltage, the power supply paths before and after the switching provide different drive supply voltages, and the drive supply voltage is a difference between the first voltage signal and the second voltage signal.

19. The drive circuit of claim 18, wherein the power supply path comprises a first power supply path and a second power supply path, the first power supply path being located between the first power supply terminal and a first voltage source, the second power supply path being located between the first power supply terminal and the second power supply terminal,
the second power supply path comprises a second voltage source or an energy storage element, and a voltage of the first voltage source is different from a voltage of the second voltage source or the energy storage element.

20. The drive circuit of claim 1, wherein the driver comprises at least one driver stage, and the first power supply terminal of a last driver stage in the driver is coupled to the first power supply terminal of the driver to receive the first voltage signal.
